(19) United States
(12) Patent Application Publication
(10) Pub. No.: US 2006/0215908 A1
(43) Pub. Date: Sep. 28, 2006

(54) Image pickup apparatus and image processing method

(75) Inventors: Koichi Kamon, Sakai-shi (JP); Kazuchika Sato, Kobe-shi (JP); Tetsuya Katagiri, Kyoto-shi (JP)

Correspondence Address: SIDLEY AUSTIN LLP, 717 NORTH HARWOOD, SUITE 3400, DALLAS, TX, 75201, US

(73) Assignee: KONICA MINOLTA HOLDINGS, INC.

(21) Appl. No.: 11/377,100

(22) Filed: Mar. 16, 2006

(30) Foreign Application Priority Data
Mar. 24, 2005 (JP) 2005-086879

(51) Int. Cl. G06K 9/00

(52) U.S. Cl. 382/167

(57) ABSTRACT

Application of a conventional color process to a LOG sensor is made possible. An image pickup apparatus includes a solid-state image sensor having two or more different photoelectric conversion characteristics and an image processing section for processing an imaging signal from the solid-state image sensor, and the image processing section includes a gradation conversion processing section for performing a gradation conversion process of unifying different photoelectric conversion characteristics to the same or bringing them close to the same and a color processing section for performing at least one of color processes including at least a color interpolation process, a color correction process, and a color space conversion process and performs the color process by the color processing section after the gradation conversion process by the gradation conversion processing section.

### RELATED APPLICATION

This application is based on Japanese Patent Application No. 2005-086879 filed on Mar. 24, 2005, in Japanese Patent Office, the entire content of which is hereby incorporated by reference.

### TECHNICAL FIELD

The present invention relates to an image pickup apparatus and an image processing method using an image sensor having a photoelectric conversion characteristic composed of two or more different characteristic areas.

### BACKGROUND

In recent years, in an image pickup apparatus such as a digital camera, in correspondence with a request of high image quality, it has been a great theme to enlarge the brightness range of an object which can be handled by the image sensor, that is, a dynamic range. With respect to the image sensor having an enlarged dynamic range, an image sensor having a photoelectric conversion characteristic composed of a linear characteristic area for linearly converting and outputting an electric signal for an incident light quantity and a logarithmic characteristic area for logarithmically converting and outputting an electric signal for an incident light quantity is known (for example, refer to Patent Document 1). The image sensor may be referred to as a LOG sensor. Further, an image having the linear characteristic and logarithmic characteristic picked up by the LOG sensor is referred to as a liner/logarithmic image.

Patent Document 1: Japanese Patent Publication Open to Public Inspection No. 2002-77733

On the other hand, generally, for a picked-up image, a color process (image processing) such as a color interpolation process or a color correction process is performed. The color process is for a linear image picked up by a conventional image sensor having a photoelectric conversion characteristic composed of one kind, that is, only a linear characteristic area and is not for a linear/logarithmic image picked up by a LOG sensor having different photoelectric conversion characteristics such as a linear characteristic area and a logarithmic characteristic area. Namely, in the case of linear/logarithmic image data picked up by the concerned LOG sensor, the photoelectric conversion characteristics are changed at a predetermined point of an output level, so that when executing the color process on a plurality of different pixels (colors), the photoelectric conversion characteristics may be different between the concerned pixels, and if the data is processed by a single photoelectric conversion characteristic using the conventional color processing method, the so-called color shift of outputting color information different from the color of an object is caused, thus the effect by the color process which is obtained conventionally cannot be obtained.

### SUMMARY

In view of forgoing, an object of this invention is to solve at least one of the problems, and to provide new apparatus. The apparatus is an image pickup apparatus, comprising:

a solid-state image sensor which has two or more different photoelectric conversion characteristics; and

an image processing section which processes an image signal outputted from the solid-state image sensor;

wherein the image processing section comprises,

a gradation conversion processing section which executes a gradation conversion process on the image signal to conform or approximate the different photoelectric conversion characteristics to each other, and

a color processing section which executes on the image signal at least one color process out of those processes which include color interpolating process, color correction process and color space conversion process,

wherein the color processing section executes the color process after the gradation conversion processing section executes the gradation conversion process.

Another aspect of the present invention is to solve at least one of the problems, and to provide a new method. The method is an image processing method processing an image signal outputted from a solid-state image sensor which has two or more different photoelectric conversion characteristics, comprises steps of:

a first process executing a gradation conversion process on the image signal to conform or approximate the different photoelectric conversion characteristics to each other; and

a second process executing on the image signal at least one color process out of those processes which include a color interpolating process, a color correction process and a color space converting process;

wherein the second process is executed after the first process.

According to another aspect of the present invention, the apparatus is an image pickup apparatus, comprising:

a solid-state image sensor which generates an electric signal in response to an amount of an incident light and has a linier characteristic region where the electric signal is converted linearly in response to an amount of the incident light and an logarithmic characteristic region, provided on a brighter side of the linear characteristic region, where the electric signal is converted logarithmically in response to the amount of the incident light; and

an image processing section which processes an image signal outputted from the solid-state image-sensor;

wherein the image processing section comprises,

a gradation conversion processing section which executes a gradation conversion process on the image signal to conform or approximate photoelectric conversion characteristics of the linear characteristic region and the logarithmic characteristic region to each other, and

a color processing section which executes on the image signal at least one of those color process which include a color interpolation process, a color correction process and a color space conversion process,

wherein the color processing section executes the color process after the gradation conversion processing section executes the gradation conversion process.

### BRIEF DESCRIPTION OF THE DRAWINGS

FIG. 1 is a schematic block diagram mainly relating to an image pickup process of a digital camera which is an example of an image pickup apparatus of this embodiment.

FIG. 2 is a graph showing an example of a photoelectric conversion characteristic of an image sensor used in the digital camera of the embodiment.

FIG. 3 is a functional block diagram for explaining the functions of a controller of the digital camera of the embodiment.

FIG. 4 is a functional block diagram showing a circuit configuration example of an image processing section of the digital cameral of the embodiment.

FIG. 5 is a drawing showing an example of the color filter structure of the image sensor of the embodiment.

FIG. 6 is a graph for explaining a process of conforming two photoelectric conversion characteristics each other within the range where those characteristic are different from each other when the standard photoelectric conversion characteristic side is a linear characteristic and the photoelectric conversion characteristic side to be corrected is a logarithmic characteristic.

FIG. 7 is a graph for explaining a process of conforming two photoelectric conversion characteristics each other within the range where those characteristic are different from each other when the standard photoelectric conversion characteristic side is a logarithmic characteristic and the photoelectric conversion characteristic side to be corrected is a linear characteristic.

FIG. 8 is a functional block diagram for explaining the function of a DR compression section of the image processing section of the embodiment.

FIG. 9 is a graph for explaining a division-extraction process of images I1 and I2 for a basic image (photoelectric conversion characteristic).

FIG. 10 is a graph for explaining a composite imaged O of images I1′ and I2′.

FIG. 11 is a flow chart showing an example of an image processing operation of the image processing section of the digital camera of the embodiment.

FIG. 12 is a graph for explaining a process of unifying the photoelectric conversion characteristics to the linear characteristic, the process is a modification example of a gradation conversion process in place of the DR compression process.

FIG. 13 is a graph for explaining a process of unifying the photoelectric conversion characteristics to the linear characteristic, the process is a modification example of a gradation conversion process in place of the DR compression process.

FIG. 14 is a graph for explaining a histogram equalization process of bringing the logarithmic characteristic to the linear characteristic, the process is a modification example of the gradation conversion process in place of the DR compression process.

### DETAILED DESCRIPTION OF THE PREFERRED EMBODIMENT

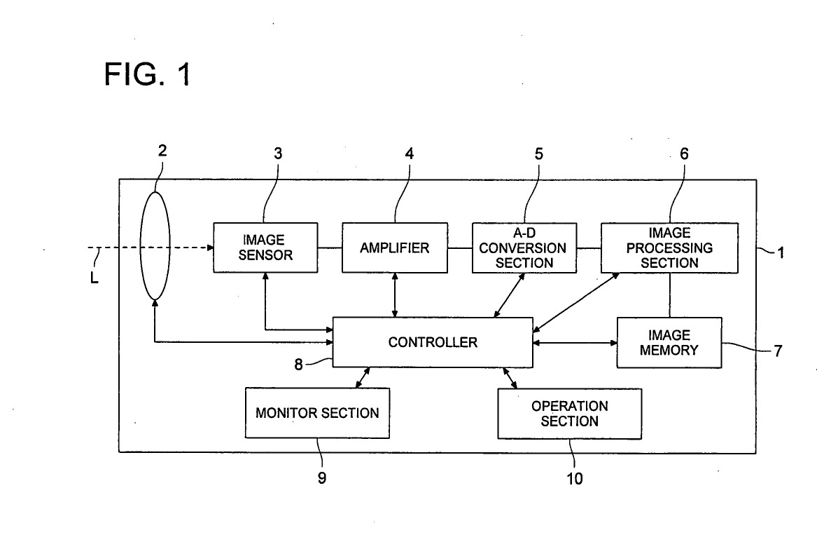

FIG. 1 is a schematic block diagram mainly relating to the image pickup process of a digital camera which is an example of the image pickup apparatus of this embodiment. As shown in FIG. 1, a digital camera 1 includes a lens section 2, an image sensor 3, an amplifier 4, an A-D conversion section 5, an image processing section 6, an image memory 7, a controller 8, a monitor section 9, and an operation section 10.

The lens section 2 functions as a lens window for taking in object light (a light image) and composes an optical lens system (for example, a zoom lens, a focus lens, and other fixed lens block arranged in series along an optical axis L of the object light) for leading the object light to the image sensor 3 arranged in the camera body. The lens section 2 includes a stop (not drawn) for adjusting transmitted light of the lens and a shutter (not drawn) and is structured so that the stop and shutter are controlled by the controller 8.

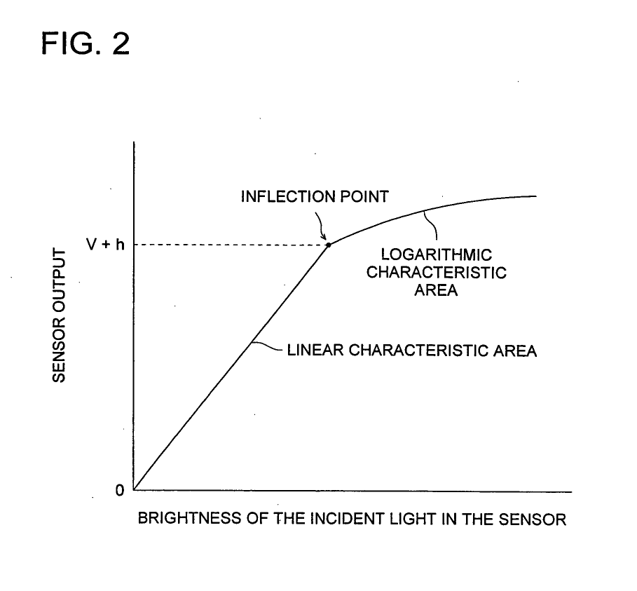

The image sensor 3, according to the light quantity of an object light image focused by the lens section 2, converts photoelectrically the image to an image signal of each component of R, G, and B, and outputs them to the amplifier 4 on the latter stage. In this embodiment, as an image sensor 3, a logarithm conversion type solid-state image sensor having photoelectric conversion characteristics composed of a linear characteristic area where, when the brightness of the incident light in the censor is low (dark) as shown in FIG. 2, an output pixel signal (an output electric signal generated by photoelectric conversion) is converted and outputted linearly and a logarithmic characteristic area where, when the brightness of the incident light in the censor is high (bight), an output pixel signal is converted and outputted logarithmically, in other words, photoelectric conversion characteristics the low brightness side of which is linear and the high brightness side of which is logarithmic is used. Further, the switching point (inflection point) of the linear characteristic area and logarithmic characteristic area of the photoelectric conversion characteristics can be controlled optionally by a predetermined control signal for each pixel circuit of the image sensor 3.

Concretely, for the image sensor 3, a logarithmic conversion circuit having a P-type (or N-type) MOSFET is added to a solid-state image sensor having photoelectric conversion elements such as photodiodes arranged in a matrix shape, and a sub-threshold characteristic of the MOSFET is used, thus the so-called CMOS image sensor in which in the output characteristic of the solid-state image sensor, an electric signal is converted logarithmically for the incident light quantity is adopted. However, it is not limited to the CMOS image sensor and a VMIS image sensor or a CCD image sensor may be used.

The amplifier 4 amplifies an image (picture) signal outputted from the image sensor 3, has, for example, an auto gain control (AGC) circuit, and adjusts the gain (amplification factor) of the concerned output signal. The amplifier 4, in addition to the AGC circuit, may have a correlated double sampling (CDS) circuit for reducing sampling noise of the concerned image signal as an analog value. Further, the AGC circuit has a function for compensating for an insufficient level of a picked-up image (correcting the sensitivity) when no appropriate exposure is obtained (for example, when taking a photograph of an object at very low brightness). Further, the gain value for the AGC circuit is set by the controller 8.

The A-D conversion section 5 converts an image signal of an analog value (an analog signal) amplified by the amplifier 4 to an image signal of a digital value (a digital signal) and converts image signals obtained by receiving light by each pixel of the image sensor 3 respectively to, for example, 12-bit pixel data.

The image processing section 6 performs various image processes (digital signal process) on an image signal obtained by the A-D conversion process by the A-D conversion section 5. In this embodiment, there is a main characteristic in an image process of enabling color processes, concretely the white balance correction process and dynamic range compression process (DR compression process), suitable for a linear/logarithmic image which is executed at the pre-stage of the color process particularly such as the color interpolation process, color correction process, and color space conversion process in each image process of the image processing section 6. Various image processes including the process relating to this characteristic point of the image processing section 6 will be described later in detail.

Further, the image processing section 6, in addition to the functions aforementioned, may include, for example, an FPN correction section for removing fixed pattern noise (FPN) of a signal and a black standard correction section for correcting the black level (image signal level at time of darkness) of a digital image signal inputted from the A-D conversion section 5 to a standard value (both are not drawn).

The image memory 7 is composed of a ROM (read only memory) or a RAM (random access memory) and retains (temporarily) image data for which the image process by the image processing section 6 is finished. The image memory 7 has a capacity capable of storing image data of predetermined frames by imaging.

The controller 8 is composed of a ROM for storing various control programs, a RAM for temporarily storing data, and a central processing unit (CPU) for reading the control programs from the ROM, executing them and managing the operation control for the whole digital camera 1. The controller 8, on the basis of various signals from the image sensor 3, image processing section 6, and operation section 10, calculates and transmits control parameters necessary for the devices aforementioned, thereby controls the operations of the devices. The controller 8, via a timing generator and a drive section which are not drawn, executes imaging operation control and zoom (focus) drive control for the image sensor 3 and lens section 2 (the stop and shutter) and executes display control for the monitor section 9. Further, the controller 8 executes output control for an image signal from the image processing section 6 and image memory 7.

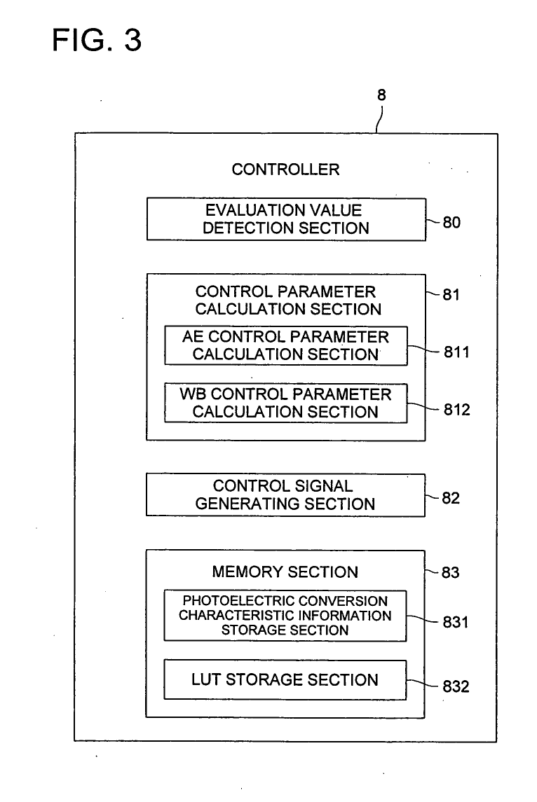

FIG. 3 is a functional block diagram for explaining the functions of the controller 8. As shown in the drawing, the controller 8 includes an evaluation value detection section 80, a control parameter calculation section 81, a control signal generating section 82, and a memory section 83. The control parameter calculation section 81 calculates control parameters necessary for the devices aforementioned and includes an AE control (automatic exposure control) parameter calculation section 811 and a WB control (white balance control) parameter calculation section 812.

Here, the definition relating the concept of AE control used in the present invention will be explained. Unlike the so-called silver halide camera, in an image pickup apparatus such as a digital camera or a digital movie, as a control element for the AE control, there are a method for controlling in association with the photoelectric conversion characteristic of the image sensor 3 (by intentionally changing the photoelectric conversion characteristic) and a method for adjusting the total quantity of light reaching the image pickup surface of the image sensor 3. In this specification, the former is called “dynamic range control” and the latter is called “exposure quantity control”. Further, the “dynamic range control”, for example, is executed by controlling the switching point (the inflection point aforementioned) of the linear characteristic area and logarithmic characteristic area of the image sensor 3. Further, the “exposure quantity control”, for example, is executed by adjustment of the stop opening amount, adjustment of the shutter speed of the mechanical shutter, or control for the integrating time of charge by control for the reset operation for the image sensor 3.

The evaluation value detection section 80 detects, from an image signal actually picked up by the image sensor 3, an evaluation value which is a base value for executing the imaging operation control such as the AE control and WB control, that is, the AE evaluation value and white balance evaluation value (WB evaluation value).

The AE control parameter calculation section 811, to execute exposure control (AE control) according to the brightness of an object, calculates a control parameter for setting an optimum exposure quantity (hereinafter referred to as an exposure quantity control parameter) at time of imaging and a control parameter for setting an optimum photoelectric conversion characteristic of the image sensor 3 (hereinafter referred to as a dynamic range control parameter). The exposure quantity control parameter is concretely a control parameter for optimizing the “exposure time” and “stop” and the dynamic range control parameter is a control parameter for optimizing the photoelectric conversion characteristic of the image sensor 3 according to the brightness of an object.

The AE control parameter calculation section 811, on the basis of the AE evaluation value detected by the evaluation value detection section 80 and the photoelectric conversion characteristic information of the image sensor 3 at the point of time when the AE evaluation value is obtained which is stored in a photoelectric conversion characteristic information storage section 831 which will be described later, calculates the exposure quantity set values such as the exposure time set value and stop set value according to the brightness of an object as exposure quantity control parameters aforementioned. Further, the AE control parameter calculation section 811, similarly on the basis of the AE evaluation value detected by the evaluation value detection section 80 and the photoelectric conversion characteristic information of the image sensor 3 at the point of time when the AE evaluation value is obtained which is stored in the photoelectric conversion characteristic information storage section 831, calculates, for example, a photoelectric conversion characteristic set value for increasing the object brightness for dynamic range setting to a desired saturation output level of the image sensor 3 as a dynamic range control parameter aforementioned.

The WB control parameter calculation section 812, on the basis of the WB evaluation value detected by the evaluation value detection section 80, calculates a WB control parameter (WB set value) for setting the color balance of an image signal to a predetermined color balance. For the calculation of the WB control parameter, it is preferable to obtain the WB evaluation value to be referred in both the logarithmic characteristic area and linear characteristic area of the image sensor 3 and calculate control parameters according to the respective characteristic areas.

Further, the control parameter calculation section 81 is not limited to calculation of the AE control parameter and WB control parameter aforementioned and may have, for example, a function for calculating an AE control parameter (AF set value) for executing auto focus control for setting an optimum focal length when imaging an object. In this case, the AF evaluation value for AF control is detected by the evaluation value detection section 80.

The control signal generating section 82, according to various control parameters calculated by the control parameter calculation section 81, generates control signals for driving the control operation elements. Concretely, the control signal generating section 82, according to the exposure time set value (exposure quantity set value) aforementioned, generates a sensor exposure time control signal for controlling the exposure time (integrating time) of the image sensor 3 by a control operation on an electronic circuit basis instead of the mechanical operation such as the stop or shutter, a shutter control signal for setting the shutter speed of the shutter (the shutter open time) in correspondence to the exposure time according to the exposure time set value (exposure quantity set value) aforementioned, a stop control signal for setting the stop opening area according to the stop set value (exposure quantity set value) aforementioned, and a dynamic range control signal for adjusting the position of the output level point (inflection point) for switching the photoelectric conversion characteristic from the linear characteristic area to the logarithmic characteristic area. Further, according to the AF set value aforementioned, the control signal generating section 82 may generate a zoom/focus control signal for driving the lenses. The control signals generated by the control signal generating section 82 are respectively transmitted to the corresponding places of the drive sections of the devices.

The memory section 83 is a storage section composed of a ROM and a RAM and includes a photoelectric conversion characteristic information storage section 831 for storing photoelectric conversion characteristic information (information for obtaining a desired photoelectric conversion characteristic at time of imaging) of the image sensor 3, that is, the exposure time set value, stop set value, and photoelectric conversion characteristic information set value (dynamic range information corresponding to the photoelectric conversion characteristic) and an LUT storage section 832 for storing conversion information for performing data conversion (mutual conversion) for image data obtained in the linear characteristic area and logarithmic characteristic area of the image sensor 3, that is, an LUT (look up table). Further, in the photoelectric conversion characteristic information storage section 831, the photoelectric conversion characteristic itself (photoelectric conversion characteristic information as shown in FIG. 2) may be stored. Further, the LUT storage section 832 stores, in addition to the LUT aforementioned, various LUTs for data conversion such as an LUT for executing data conversion between the exposure time and stop opening area and the exposure time set value and stop set value and an LUT for executing data conversion between the value (output level) at the inflection point of the photoelectric conversion characteristic and the photoelectric conversion characteristic set value.

The monitor section 9 displays an image picked up by the image sensor 3 (image stored in the image memory 7) on the monitor. The monitor section 9 is concretely composed of, for example, a liquid crystal display (LCD) composed of a color liquid crystal element arranged on the back of a camera or an electronic view finder (EVF) composing an eye section.

The operation section 10 gives an operation instruction (instruction input) by a user to the digital camera 1 and is composed of various operation switches (operation buttons) such as a power switch, a release switch, a mode setting switch for setting various imaging modes, and a new selection switch. For example, when the release switch is pressed (turned on), the imaging operation (a series of imaging operations such that an object is imaged by the image sensor 3, and a predetermined imaging process is performed for the image data obtained by the concerned imaging, and then it is stored in the image memory 7) is executed.

Next, the constitution and operation of the image processing section 6 will be explained below in detail.

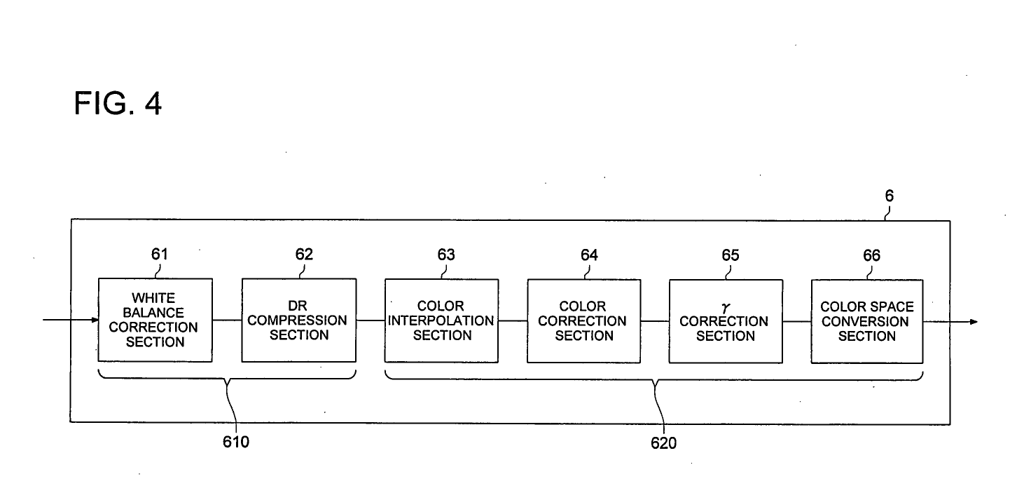

FIG. 4 is a functional block diagram showing a circuit configuration example of the image processing section 6. As shown in FIG. 4, the image processing section 6 includes a white balance correction section 61, a DR compression section 62, a color interpolation section 63, a color correction section 64, a γ correction section 65, and a color space conversion section 66.

The white balance correction section 61 makes a color balance correction in correspondence with white color change caused by color temperature change of the light source for an object, that is, makes a correction of converting the level of each pixel data of each color component of R, G, and B so as to set the color balance of an image signal to a predetermined color balance on the basis of the dynamic range information and WB evaluation value given from the controller 8. Here, the image sensor 3 has the photoelectric conversion characteristic composed of a linear characteristic area and a logarithmic characteristic area, so that it is desirable to obtain a WB evaluation value every linear characteristic and logarithmic characteristic area and make a white balance correction suitable to each area.

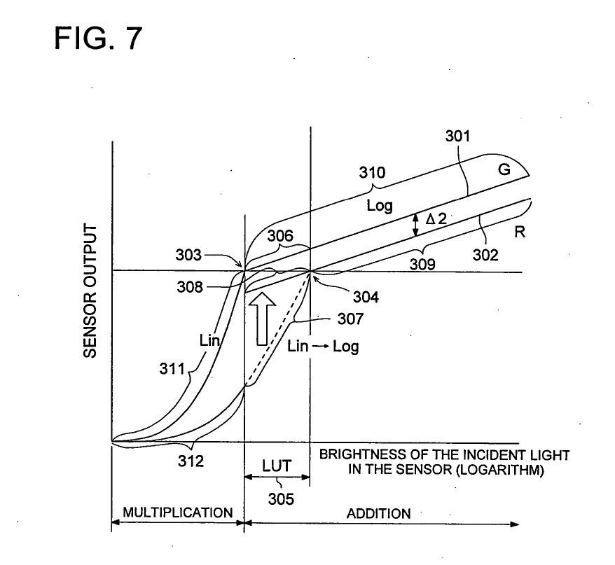

In this embodiment, the white balance correction section 61 performs a correction process of making the photoelectric conversion characteristic of a color to be corrected, that is, the colors R and B coincide with (fit to) the photoelectric conversion characteristic of the color G which is generally a standard color. With respect to the process of making the photoelectric conversion characteristic of each of the colors R and B coincide with the photoelectric conversion characteristic of the standard color G, the photoelectric conversion characteristic of each of the colors R, G, and B has a linear characteristic area and a logarithmic characteristic area, and the characteristics (the shape of each characteristic curve) are different from each other, so that as shown in certain coordinates of brightness of the incident light in the censor, there is a range where a certain part of the linear characteristic area (logarithmic characteristic area) of the photoelectric conversion characteristic of one color is overlaid on the logarithmic characteristic area (linear characteristic area) of the photoelectric conversion characteristic of the other color, so that as shown in the two cases in FIGS. 6 and 7, the process of making the concerned photoelectric conversion characteristics coincide with each other is performed.

FIG. 6 is a graph for explaining the process of making the photoelectric conversion characteristics coincide with each other within the range where those characteristic are different from each other when the standard photoelectric conversion characteristic side is a linear characteristic and the photoelectric conversion characteristic side to be corrected is a logarithmic characteristic. On the other hand, FIG. 7 is a graph for explaining the process of making the photoelectric conversion characteristics coincide with each other within the range where those characteristic are different from each other when the standard photoelectric conversion characteristic side is a logarithmic characteristic and the photoelectric conversion characteristic side to be corrected is a linear characteristic. Firstly, in FIG. 6, numeral 201 indicates a photoelectric conversion characteristic (photoelectric conversion characteristic 201) of the standard color G and numeral 202 indicates a photoelectric conversion characteristic (photoelectric conversion characteristic 202) of the color R to coincide with the photoelectric conversion characteristic of the standard color G. However, here, as a color to coincide with the photoelectric conversion characteristic of the standard color G, among the colors R and B, the color R is used (hereinafter, the same may be said with FIG. 7). The photoelectric conversion characteristics 201 and 202 have a linear characteristic area and a logarithmic characteristic area respectively having inflection points (switching points) 203 and 204.

The photoelectric conversion characteristics 201 and 202 respectively have a linear characteristic area 206 and a logarithmic characteristic area 207 in an area (range) 205 of the brightness of the incident light in the sensor in the axis of abscissa and are different from each other. Therefore, to make the photoelectric conversion characteristic 202 coincide with the photoelectric conversion characteristic 201, firstly, the image data of the logarithmic characteristic area 207 is converted to a linear characteristic value, that is, a value corresponding to a linear characteristic area 208 using the LUT and is unified to linear data of the same characteristic as the characteristic of the linear characteristic area 206. And, linear data obtained by adding the concerned linear data obtained by conversion to linear data in a linear characteristic area 209 (referred to as composite linear data) is multiplied with a predetermined correction coefficient, thereby coincides with linear data in a linear characteristic area 210. However, the correction coefficient is a value based on the ratio of the composite linear data value aforementioned to the linear data value (sensor output value) in the linear characteristic area 210 and is given by, for example, a ratio of a value equivalent to a length H1 for each brightness of the incident light in the censor to a value equivalent to a length H2 (H2/H1, a symbol of “/” indicates division).

On the other hand, with respect to the logarithmic character areas of the photoelectric conversion characteristics 201 and 202, that is, logarithmic characteristic areas 211 and 212 (the logarithmic characteristic area 207 converted to linear data is excluded), logarithmic data in the logarithmic characteristic area 212 is added with a predetermined correction value, thereby coincides with logarithmic data in the logarithmic characteristic area 211. Further, this correction value is given as a difference Δ1 between the logarithmic data value (sensor output value) in the logarithmic characteristic area 212 and the logarithmic data value (sensor output value) in the logarithmic characteristic area 211. However, in the case shown in FIG. 6, the difference Δ1 as a negative value is added (the difference Δ1 as a positive value may be subtracted).

As mentioned above, the photoelectric conversion characteristics 201 and 202 are unified to the photoelectric conversion characteristic of either of them, here to the characteristic of the photoelectric conversion characteristic 201 of the color G which is a standard, and then a predetermined gain for the image data in each of the characteristic areas, that is, the correction coefficient and correction value aforementioned are used, thus a process of making the photoelectric conversion characteristic 202 coincide with the photoelectric conversion characteristic 201 is performed. Further, when making the photoelectric conversion characteristic of the color B coincides with the photoelectric conversion characteristic 201 of the color G, the same process is performed as aforementioned.

Next, in FIG. 7, numeral 301 indicates a photoelectric conversion characteristic (photoelectric conversion characteristic 301) of the standard color G and numeral 302 indicates a photoelectric conversion characteristic (photoelectric conversion characteristic 302) of the color R to coincide with the photoelectric conversion characteristic of the standard color G. The photoelectric conversion characteristics 301 and 302 have a linear characteristic area and a logarithmic characteristic area respectively having inflection points (switching points) 303 and 304.

The photoelectric conversion characteristics 301 and 302 respectively have a logarithmic characteristic area 306 and a linear characteristic area 307 in an area (range) 305 of the brightness of the incident light in the censor in the axis of abscissa and are different from each other. Therefore, to make the photoelectric conversion characteristic 302 coincide with the photoelectric conversion characteristic 301, firstly, the image data in the linear characteristic area 307 is converted to a logarithmic characteristic value, that is, a value in a logarithmic characteristic area 308 using the LUT and is unified to logarithmic data of the same characteristic as the characteristic of the logarithmic characteristic area 306. And, logarithmic data obtained by adding the concerned logarithmic data obtained by conversion to logarithmic data in a logarithmic characteristic area 309 (referred to as composite logarithmic data) is added with a predetermined correction value, thereby coincides with logarithmic data in a logarithmic characteristic area 310. However, the correction value is given as a difference Δ2 between the composite logarithmic data value (sensor output value) aforementioned and the logarithmic data value (sensor output value) in the logarithmic characteristic area 310.

On the other hand, with respect to the linear character areas of the photoelectric conversion characteristics 301 and 302, that is, a linear characteristic area 311 and a logarithmic characteristic area 312 (the logarithmic characteristic area 307 converted to logarithmic data is excluded), linear data in the concerned linear characteristic area 312 is multiplied with a predetermined correction coefficient, thereby coincides with linear data in the linear characteristic area 311. The correction coefficient, similarly to the aforementioned, is a value based on the ratio between the linear data values (sensor output values) in the linear characteristic area 311 and logarithmic characteristic area 312.

As mentioned above, the photoelectric conversion characteristics 301 and 302 are unified to the photoelectric conversion characteristic of either of them, here to the characteristic of the photoelectric conversion characteristic 301 of the color G which is a standard, and then a predetermined gain for the image data in each of the characteristic areas, that is, the correction value and correction coefficient aforementioned are used, thus a process of making the photoelectric conversion characteristic 302 coincide with the photoelectric conversion characteristic 301 is performed. Further, when making the photoelectric conversion characteristic of the color B coincides with the photoelectric conversion characteristic 301 of the color G, the same process is performed.

As explained above in FIGS. 6 and 7, when both colors R and G have a linear characteristic, the multiplication for the color R is performed straight and when both colors R and G have a logarithmic characteristic, the addition for the color R is performed straight (this is a basic processing operation). When the respective characteristics are different from each other, for example, when the color R has a logarithmic characteristic and the color G has a linear characteristic, the logarithmic characteristic of the color R is converted to a linear characteristic using the LUT, and then the multiplication for it is performed. Further, for example, when the color R has a linear characteristic and the color G has a logarithmic characteristic, the linear characteristic of the color R is converted to a logarithmic characteristic using the LUT, and then the addition for it is performed.

Further, the process (white balance correction process) of making the photoelectric conversion characteristics coincide with each other may be said to be a process of clearly dividing all the photoelectric conversion characteristics of the colors R, G, and B into a linear characteristic and a logarithmic characteristic with a certain brightness value bounded by and handling them together (in a batch) as the same characteristic. Further, the correction value added to the image data in the aforementioned addition and the correction coefficient multiplied by the image data in the multiplication are calculated by the controller 8 (for example, the white balance correction section 61). However, the controller 8 calculates the correction value and correction coefficient on the basis of the WB evaluation value detected by the evaluation value detection section 80. Further, here, as a preferable configuration, the color G is selected as a standard color of R, G, and B. However, the color R or B may be selected as a standard color and in this case, a constitution that a process of making the photoelectric conversion characteristics of the colors G and B coincide with the photoelectric conversion characteristic of the standard color R or making the photoelectric conversion characteristics of the colors G and R coincide with the photoelectric conversion characteristic of the standard color B is performed may be used.

The DR compression section 62 has a function for performing the DR compression process for a linear/logarithmic image obtained by the image sensor 3 when correcting the gradation characteristic of the display system aforementioned. In the schematic explanation, the DR compression section 62 has a function for dividing input image data into image data in the logarithmic characteristic area and linear characteristic area (division-extraction process), executing a compression process of the lighting component for each of the concerned divided image data in the linear characteristic area and logarithmic characteristic area, and then composing these respective image data. The concrete constitution and operation relating to this function of the DR compression section 62 will be explained later in detail.

The color interpolation section 63 performs a color interpolation process of interpolating insufficient data of the pixel position of a frame image for each of the color components R, G, and B of an input image signal. Namely, the color filter structure of the logarithmic conversion type image sensor 3 used in this embodiment adopts the so-called Bayer system in which, for example, G is checkered and R and B are in a line sequential arrangement shape (hereinafter, referred to as G checkered RB line sequential arrangement) and due to this relationship, color information is insufficient, so that the color interpolation section 63 interpolates pixel data of an unreal pixel position using a plurality of existent pixel data.

Concretely, the color interpolation section 63, for a frame image of the color component of the color G having pixels including a high-frequency area, masks the image data composing the frame image with a predetermined filter pattern, then using a median (an intermediate value) filter, among the pixel data existing around the pixel position to be interpolated, calculates a mean value of the pixel data with the maximum and minimum values removed, and interpolates the mean value as pixel data at the concerned pixel position. Further, for the color components of R and B, the color interpolation section 63 masks the image data composing the frame image with the predetermined filter pattern, then calculates a mean value of the pixel data existing around the pixel position to be interpolated, and interpolates the mean value as pixel data at the concerned pixel position.

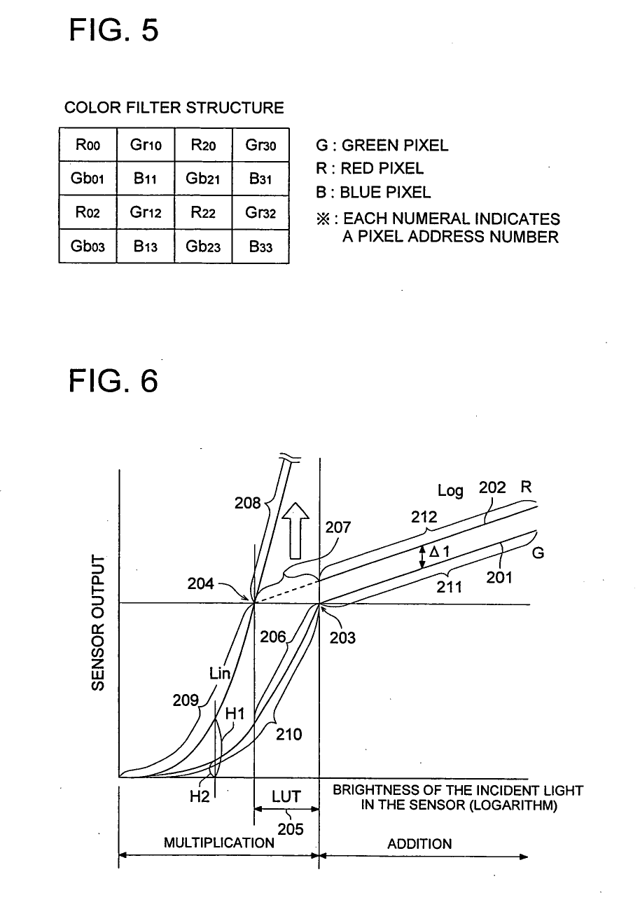

FIG. 5 shows an example of the color filter structure of the image sensor 3. In such a color filter structure, image signals of the color components R, G, and B of each pixel by the color interpolation aforementioned are generated, for example, by the following color interpolation formulas.

(a) Color Interpolation Formula at Address 11 (B11)
R11=(R00+R20+R02+R22)/4
G11=(Gr10+Gb01+Gb21+Gr12)/4
B11=B11
(b) Color Interpolation Formula at Address 12 (Gr12)
R12=(R02+R22)/2
G12=Gr12
B12=(B11+B13)/2
(c) Color Interpolation Formula at Address 21 (Gb21)
R21=(R20+R22)/2
G21=Gb21
B21=(B11+B31)/2
(d) Color Interpolation Formula at Address 22 (R22)
R22=R22
G22=(Gb21+Gr12+Gr32+Gb23)/4
B22=(B11+B31+B13+B33)/4

As mentioned above, when executing the interpolation process on the basis of color information of different pixels and processing images having different photoelectric conversion characteristics, the photoelectric conversion characteristics of a plurality of pixels used for interpolation may be different such as a linear characteristic and a logarithmic characteristic and at time of interpolation, it is necessary to perform interpolation in consideration of the photoelectric conversion characteristic of each pixel (for example, when any one pixel information of the pixels R00, Gr10, - - - is a logarithmic characteristic, a color shift occurs). However, in this embodiment, the photoelectric conversion characteristics are made uniform before the interpolation process, that is, for all the color characteristics of R, G, and B, the linear characteristic and logarithmic characteristic are set so as to coincide with each other, so that unless the exclusive color interpolation section 63 (the color interpolation formula) of image data of the photoelectric conversion characteristic having the linear characteristic and logarithmic characteristic is installed particularly, the colors can be processed by the conventional interpolation process (the interpolation process of handling the linear information aforementioned).

The color correction section 64 performs a color correction process of correcting the color balance (saturation) of image signals of the color components R, G, and B inputted from the color interpolation section 63. The color correction section 64 has three conversion coefficients for converting the level ratio of each image signal of the color components R, G, and B, converts the level ratio by the conversion coefficient according to an imaging scene, and corrects the color balance of image data. For example, the color correction section 64, using 9 conversion coefficients of a1 to c3 (weight factors), linearly converts image signals using the color correction conversion formulas indicated below.
R′=a1×R+a2×G+a3×B
G′=b1×R+b2×G+b3×B
B′=c1×R+c2×G+c3×B

where a symbol * indicates a multiplication (the same may be said with * used in the subsequent formulas).

As mentioned above, when correcting the color information of pixels by a predetermined coefficient and processing images having different photoelectric conversion characteristics, the photoelectric conversion characteristics of a plurality of color information used for interpolation may be different from each other such as the linear characteristic and logarithmic characteristic and at time of interpolation, it is necessary to perform interpolation in consideration of the photoelectric conversion characteristic of each color (for example, when any one color of R, G, and B in the color correction formulas aforementioned has a logarithmic characteristic, a color shift occurs). However, in this embodiment, the photoelectric conversion characteristics are made uniform before the interpolation process, that is, for all the color characteristics of R, G, and B, the linear characteristic and logarithmic characteristic are set so as to coincide with each other, so that unless the exclusive color correction section 64 (the color correction formula) of image data of the photoelectric conversion characteristic having the linear characteristic and logarithmic characteristic is installed particularly, the colors can be processed by the conventional correction process (the correction process of handling the linear information aforementioned).

The γ correction section 65 performs a γ correction process of non-linear conversion using a predetermined gamma characteristic for input image data. Concretely, the γ correction section 65, to set each image signal of the input color components R, G, and B on an appropriate output level, performs a non-linear correction for the level of each image signal for each color component using a predetermined gamma correction table (gamma correction LUT) according to the display characteristics (gradation characteristic, non-linear display characteristic, γ curve) of a display medium such as the monitor section 9 or monitor television outputted externally. However, for the gamma correction table, a one according to the display characteristics of the display medium is stored (set) beforehand in the LUT storage section 832.

When the photoelectric conversion characteristic composed of a linear characteristic and a logarithmic characteristic was different for each of the colors R, G, and B according to imaging, it was necessary to switch and use the gamma correction table for the concerned imaging, that is, for each color. However, in this embodiment, the photoelectric conversion characteristics are made uniform before the correction process, that is, for all the color characteristics of R, G, and B, the linear characteristic and logarithmic characteristic are set so as to coincide with ones of each color, so that the colors can be processed efficiently using the same gamma correction table. Further, conventionally, the gamma correction is generally performed after execution of the color interpolation and color correction, so that also in this embodiment, a constitution that the γ correction section 65 is installed on the latter stage of the color interpolation section 63 and color correction section 64 is used.

The color space conversion section 66 performs a color space conversion process of converting the color space from the RGB display system for expressing by three color gradations of red (R), green (G), and blue (B) in image data to the YCbCr display system (may be referred to as a YCC display system) for expressing by a color difference (Cb) between brightness (Y) and blue and a color difference (Cr) between brightness (Y) and red. The color space conversion process by the color space conversion section 66, when handling image data having different photoelectric conversion characteristics in this embodiment, if it is performed after gamma correction, can be handled without trouble regardless of existence of a process by the white balance correction section 61 and DR compression section 62. However, if it is performed before gamma correction, when the gamma data having different photoelectric conversion characteristics is subject straight (without unified to one characteristic) to the color space conversion process, a problem arises that the hue slips. However, in this embodiment, the process by the white balance correction section 61 and DR compression section 62 (the preceding process which will be described later) is performed, so that this problem can be dissolved.

On the other hand, the image processing section 6, as mentioned above, can be broadly divided into a preceding processing section (preceding processing section 610) for unifying the photoelectric conversion characteristics of image data to the same characteristic (linear characteristic) and a succeeding processing section (succeeding processing section 620) for the concerned image data having the unified characteristic. The image process of the succeeding processing section 620 indicates the so-called “color process” performed by the image process of the color interpolation section 63, color correction section 64, and color space conversion section 66. However, the white balance correction process performed by the white balance correction section 61 is one kind of the “color process”, so that to clearly distinguish between the preceding process and the succeeding process, the color process performed by the succeeding processing section 620 is referred to as “succeeding color process”. The “succeeding color process” may include the gamma correction process performed by the γ correction section 65.

Further, in the preceding processing section 610, the white balance correction section 61 may be arranged on the succeeding stage of the DR compression section 62. Namely, the concerned preceding process may be structured so as to perform the white balance correction process after execution of the DR compression process. Further, the function section for performing the succeeding process of the succeeding processing section 620 is not limited to the one shown in FIG. 4, and for example, the succeeding processing section 620 may further include a function section for performing a saturation emphasis process for emphasizing the color saturation on the basis of the CbCr color difference information of the YCbCr display system aforementioned.

Here, the image process (gradation conversion process) of the DR compression section 62 will be described in detail. In FIG. 4, a linear/logarithmic image subject to the white balance correction process by the white balance correction section 61 is subject to the DR compression process by the DR compression section 62.

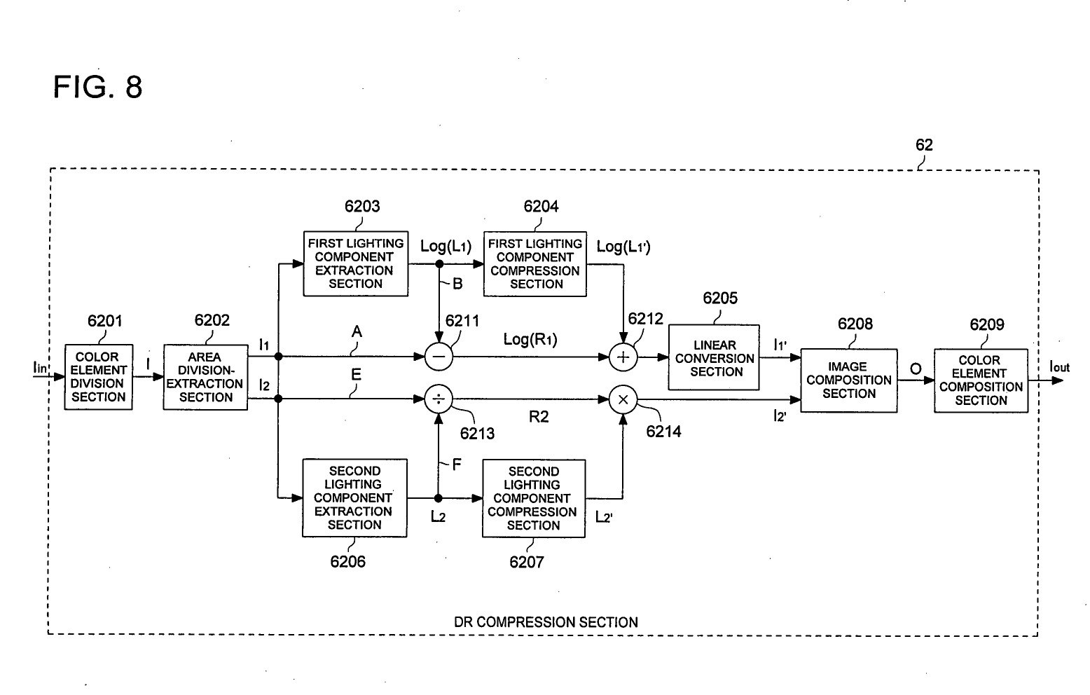

FIG. 8 is a functional block diagram for explaining the function of the DR compression section 62. As shown in the drawing, the DR compression section 62 includes a color element division section 6201, an area division-extraction section 6202, a first lighting component extraction section 6203, a first lighting component compression section 6204, a linear conversion section 6205, a second lighting component extraction section 6206, a second lighting component compression section 6207, an image composition section 6208, and a color element composition section 6209. Hereinafter, these function sections will be explained together with a concrete calculation method.

The color element division section 6201 divides image data from the image sensor 3, which is here an image Iin (linear/logarithmic image) from the preceding white balance correction section 61, into image data for each four color elements (R, Gr, Gb, B) in the G checkered RB line sequential arrangement having the Bayer system color filter structure, that is, obtains four kinds of color image data (R image, Gr image, Gb image, and B image) obtained by dividing the four Bayer elements into each elements. Further, the image size of each color image is ½ of the original image size. Further, the four kinds of color images are respectively linear/logarithmic images including linear characteristic information and logarithmic characteristic information.

The area division-extraction section 6202, in the respective aforementioned four kinds of color images inputted from the color element division section 6201 (each color image is expressed as a basic image I), divides and extracts from the basic images I an image (image I1) in the logarithmic characteristic area and an image (image I2) in the linear characteristic area.

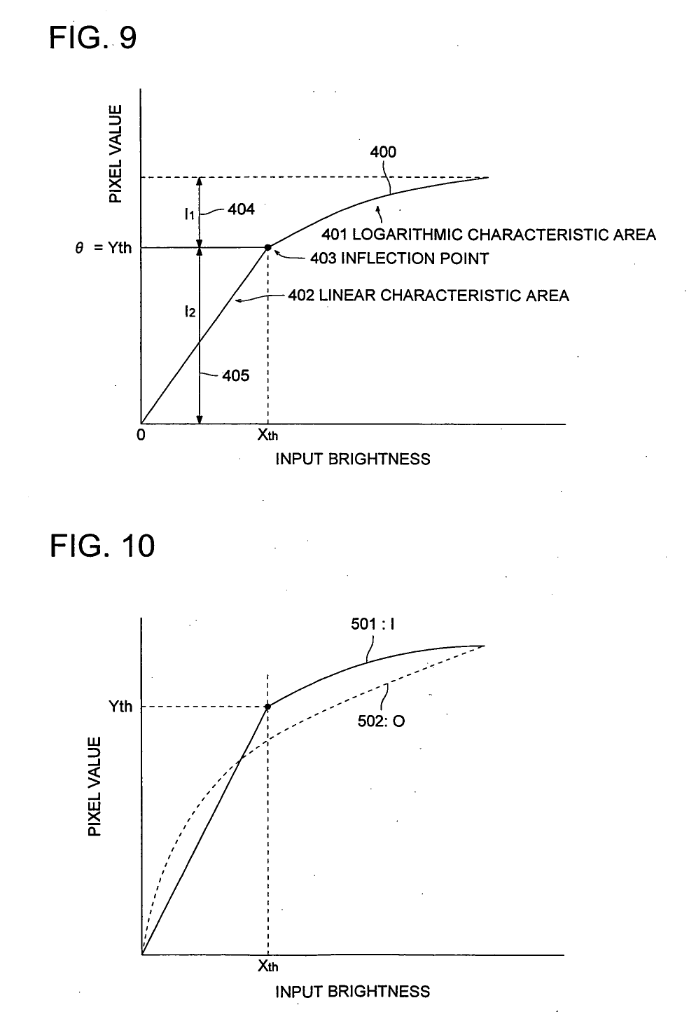

The basic image I for each color image which is inputted from the color element division section 6201 to the area division-extraction section 6202 has, for example, a photoelectric conversion characteristic 400 shown in FIG. 9, and the photoelectric conversion characteristic 400 is expressed as Formulas (1-1) and (1-2) indicated below as a pixel value y to input brightness x (not a logarithmic value). The coordinates Xth and Yth shown in the drawing are values of each coordinates (x, y) at the switching point where a logarithmic characteristic area 401 and a linear characteristic area 402 of the photoelectric conversion characteristic 400 are switched, that is, a inflection point 403. However, “input brightness” and “pixel value” shown in the drawing are equivalent respectively to “brightness of the incident light in the censor” and “sensor output” shown in FIG. 2.
y=a×x+b(0≦x≦Xth) (1-1)
y=α×log(x)+β(Xth≦x) (1-2)

(Formula (1-1) indicates the linear characteristic area 402 and Formula (1-2) indicates the logarithmic characteristic area 401.)

The area division-extraction section 6202, as shown in Conditional Formulas (2-1) to (2-4) indicated below, divides each pixel composing the basic image I (here, to indicate a two-dimensional image, it is expressed as an image I(x, y) when necessary) into an area having a pixel value of a predetermined value θ or larger and an area of a pixel value smaller than the predetermined value θ (the basic image I is clipped by θ at the upper limit and lower limit positions of each characteristic area). The θ is referred to as a division parameter when necessary.

(I(x, y)≧θ)
then
   I1(x, y)=I(x, y) (2-1)
   I2(x, y)=0(zero) (2-2)
   else
   I1(x, y)=0(zero) (2-3)
   I2(x, y)=I(x, y) (2-4)

endif

This indicates that in the image I(x, y), an image in the area where the pixel value is θ or larger is the image I1 (image I1(x, y)) and an image in the area where the pixel value is smaller than θ is the image I2(image I2 (x, y)).

However, in this embodiment, as shown in FIG. 9, the whole image having the photoelectric conversion characteristic 400 is divided into an image in the linear characteristic area and an image in the logarithmic area, so that the position of the division parameter θ is the same position as that of Yth at the inflection point aforementioned (the division parameter θ is fixed and set only to the value of Yth). Therefore, the boundary position between the linear characteristic and the logarithmic characteristic of the division-extraction process may not be set using the division parameter θ, and for example, it may be set just as a position of the inflection point Yth.

As mentioned above, the area division-extraction section 6202, when the basic image I having the photoelectric conversion characteristic 400 is input, performs a division-extraction process of dividing the basic image I, with the division parameter θ (=Yth, the inflection point) being as a division of two images, into the image I1 (logarithmic characteristic image) shown in an area 404 and the image I2 (linear characteristic image) shown in an area 405. The setting information of the division parameter θ may be stored in the DR compression section 62 (for example, the area division-extraction section 6202).

On the other hand, the basic image I, according to the so-called Retinex theory, assuming the lighting component of the basic image I in the basic image I as a lighting component L and the reflectance component as a reflectance component R, is expressed by Formula (3-1) indicated below.
I=L×R (3-1)

However, Formula (3-1) is a one for the basic image I as a linear characteristic area image and the basic image I as a logarithmic characteristic area image is expressed by Formula (4-1) indicated below.
Log(I)=Log(L)+Log(R) (4-1)

As shown in FIG. 9, the image I1 in which the pixel value of the basic image I is θ(=Yth) or larger is an image in the logarithmic characteristic area 401 equivalent to Formula (1-2) of the area 404 and is expressed by Formula (5-1) indicated below. Further, the image I2 is an image in the linear characteristic area 402 equivalent to Formula (1-1) of the area 405.
I1=α×log(x)+β (5-1)

Assuming the pixel value before logarithmic conversion, that is, one pixel of the image I1 as i1, the left side of Formula (4-1) becomes Log(i1) and Log(i1) is expressed by Formula (6-1) indicated below which is a modification of Formula (5-1).
log(i1)=(I1−β)/α (6-1)

The first lighting component extraction section 6203, from the image I1 among the images I1 and I2 divided and extracted from the basic image I, extracts the lighting component, that is, Log (L1) as a lighting component of the image I1 (a logarithmic value of the lighting component L1 of the image I1). The lighting component can be approximated by a low frequency component of an image, so that it is expressed by Formula (7-1) indicated below.
Log(L1)=F(log(i1)) (7-1)

The conversion indicated by “F” in Formula (7-1) indicates a linear low-pass filter (LPF) relating to Gaussian or averaging. When the filter is linear like this, Formula (7-1) is expressed by Formula (8-1) indicated below by substituting Formula (6-1) (since the linear filter is used, “F” is expressed by a formula relating only to the item (I1)). Formula (8-1) indicates that the lighting component Log (L1) is obtained from the image I1 by the calculation expression of the right side of Formula (8-1) using the LPF.
Log(L1)=(F(I1)−β)/α (8-1)

However, the filter is not limited to the linear filter aforementioned, and in short, if the so-called shaded image is obtained, for example, a non-linear filter such as a median filter may be used. In this case, even if the non-linear filter is applied, the value is not changed largely, so that it can be used for the concerned process.

The first lighting component compression section 6204 performs a compression process for a lighting component image extracted by the first lighting component extraction section 6203. Namely, the first lighting component compression section 6204 performs a predetermined compression process for the extracted lighting component Log (L1) aforementioned and outputs it as a logarithmic value Log (L1′) of a lighting component L1′ obtained by compressing the concerned lighting component L1. Assuming the compressibility (DR compressibility) of the DR compression as “r”, Log (L1′) outputted from the first lighting component compression section 6204 is expressed by Formula (9-1) indicated below.
Log(L1′)=Log(L1)×r (9-1)

Assuming the image after DR compression for the image I1 as an image I1′ and the reflectance component of the image I1 as R1, Formula (4-1) is expressed by Formula (10-1) indicated below:
Log(I1′)=Log(L1′)+Log(R1) (10-1)

so that the image I1′ is expressed by Formula (11-1) indicated below which is an inverse logarithm of both sides of Formula (10-1).
I1′=exp(Log(L1′)+Log(R1)) (11-1)

The linear conversion section 6205 converts a logarithmic image which is divided and extracted by the area division-extraction section 6202 and is subject to the compression process by the first lighting component extraction section 6203 and first lighting component compression section 6204 to a linear image. Concretely, the linear conversion section 6205 performs calculations by formula conversion from Formula (10-1) to Formula (11-1), thereby performs the conversion process from the logarithmic image Log (I1′) to the linear image I1′. The logarithmic image Log (I1′) is converted to the linear image I1′ by the linear conversion section 6205 in this way, thus it can be handled as an image having the same characteristic (linear characteristic) as that of the image I2′ which is a linear image which will be described later (here, the composite process of the images I1′ and I2′ can be performed).

Further, as shown in FIG. 8, Log (R1) aforementioned is obtained by subtracting the lighting component Log (L1) to which the route B is transmitted from the image I1 to which the route A is transmitted by a subtraction section 6211. Further, the image I1′ is obtained by adding the compression lighting component Log (L1′) from the first lighting component compression section 6204 and the reflectance component Log (R1) from the subtraction section 6211 by an addition section 6212. Further, in the above description, it is expressed that the route is transmitted to the image. However, as an actual operation, an image data signal (an image signal) is impressed on the concerned overall route.

Among the images I1 and I2 extracted by the area division-extraction section 6202, the image I2 is subject to the DR compression by the following method by the second lighting component extraction section 6206 and second lighting component compression section 6207 and is input to the image composition section 6208 as an image I2′. This will be explained below.

The second lighting component extraction section 6206 extracts the lighting component L2 from the image I2 divided and extracted by the area division-extraction section 6202. The extraction process of the lighting component L2 from the concerned image I2 is expressed by Formula (14-1) indicated below.
L2=F(I2) (14-1)

Here, “F” in Formula (14-1), in the same way as aforementioned, indicates a linear low-pass filter relating to Gaussian or averaging. The filter may be a non-linear filter such as a median filter. On the other hand, the reflectance component R2 of the image I2 is obtained from a relationship of R2=I2/L2 (refer to Formula (3-1)).

The second lighting component compression section 6207 performs a predetermined compression process for the lighting component L2 obtained by the second lighting component extraction section 6206 and outputs the lighting component L2′ obtained by compressing the concerned lighting component. Assuming the DR compressibility as “c”, the compression lighting component L2′ is given by Formula (15-1) indicated below.
L2′=exp(Log(L2)×c) (15-1)

The compression lighting component L2′ obtained by the second lighting component compression section 6207 is multiplied by the reflectance component R2 by a multiplication section 6214 and as a result, the image L2′ after the DR compression process for the image I2′ is obtained. The reflectance component R2 is obtained by dividing the lighting component L2 to which the route F is transmitted by the image I2 to which the route E is transmitted by a division section 6213.

The image composition section 6208 prepares a composite image of a linear image and a logarithmic image after the DR compression process aforementioned. Namely, the image composition section 6208 prepares a composite image O on the basis of the image I1′ obtained by the DR compression process for the image I1 and the image I2′ obtained by the DR compression process for the image I2 (O=I1′+I2′). The image I1′ (logarithmic characteristic image) and the image I2′ (linear characteristic image) are connected (composed) smoothly as shown by a photoelectric conversion characteristic 502 in FIG. 10. However, to realize the concerned smooth connection, for the compressibility r and compressibility c aforementioned, r=c is held. Further, the image composition section 6208 may perform the composition process of the composite image O and basic image I (in this case, the DR compression section 62 is structured (wired) so as to input the data of the basic image I to the image composition section 6208). The composition process of the image O and basic image I, concretely, may be performed, for example, by performing a simple addition-averaging process (averaging) of the whole of the image O and basic image I or by performing the addition-averaging process of the image O and basic image I, for example, only in the area of Xth or larger (obtaining a mean image) and composing the mean image with a smaller area of the basic image I (the linear characteristic area part of the photoelectric conversion characteristic 501) than Xth (in this case, the overlaid parts of the images may be composed, for example, by the weighted average process). As mentioned above, a new composite image is prepared on the basis of the composite image O and basic image I, thus the characteristic graph is suppressed from rising in the linear characteristic area, and the contrast in the concerned linear characteristic area is prevented from excessive emphasis, and on the other hand, the pixel value width in the logarithmic characteristic area is enlarged, and the contrast can be improved (it may be said that the contrast in the logarithmic characteristic area can be brought close to the contrast in the linear characteristic area). And, an image data in which the contrast in the concerned logarithmic characteristic area is improved can be handled, thus the quality of an image displayed on the display unit can be improved.

The color element composition section 6209 composes the images O obtained by the image composition section 6208, that is, the four kinds of images O corresponding to the color images I (the R image, Gr image, Gb image, and B image aforementioned) for each element of the four Bayer elements aforementioned and obtains an image Iout also having the image information of the original four elements. Further, the image size is returned from the ½ size of the images O to the same size of the image Iout. Further, the image Iout is an image including only the linear characteristic information (unified to the linear characteristic image data).

As mentioned above, the DR compression process (gradation conversion process) is performed by the DR compression section 62, thus images having different photoelectric conversion characteristics can be converted to images having the same photoelectric conversion characteristic, and in picked-up images, the contrast of a low-contrast part can be emphasized (improved). Namely, a process of extracting the base (illumination light component) for each local space of an image (the linear characteristic area and logarithmic characteristic area), compressing the extracted base, and converting to the same photoelectric conversion characteristic as that of the linear characteristic area together with the reflectance component of the image (the process by the linear conversion section 6205), thus the image data composed of the logarithmic characteristic and linear characteristic can be unified to image data of the linear characteristic, and in addition to it, the contrast in the logarithmic characteristic area can be emphasized (improved). In either case, by the DR compression process by the DR compression section 62, the picked-up image data is unified to the photoelectric conversion characteristic of the low-brightness area, thereby can be handled as image data having the same characteristic, and in the subsequent image process, data can be handled easily (the calculation can be simplified and the process can be speeded up). Here, the succeeding color process by the succeeding processing section 620 can be performed efficiently using the conventional color processing section (color processing method) as it is.

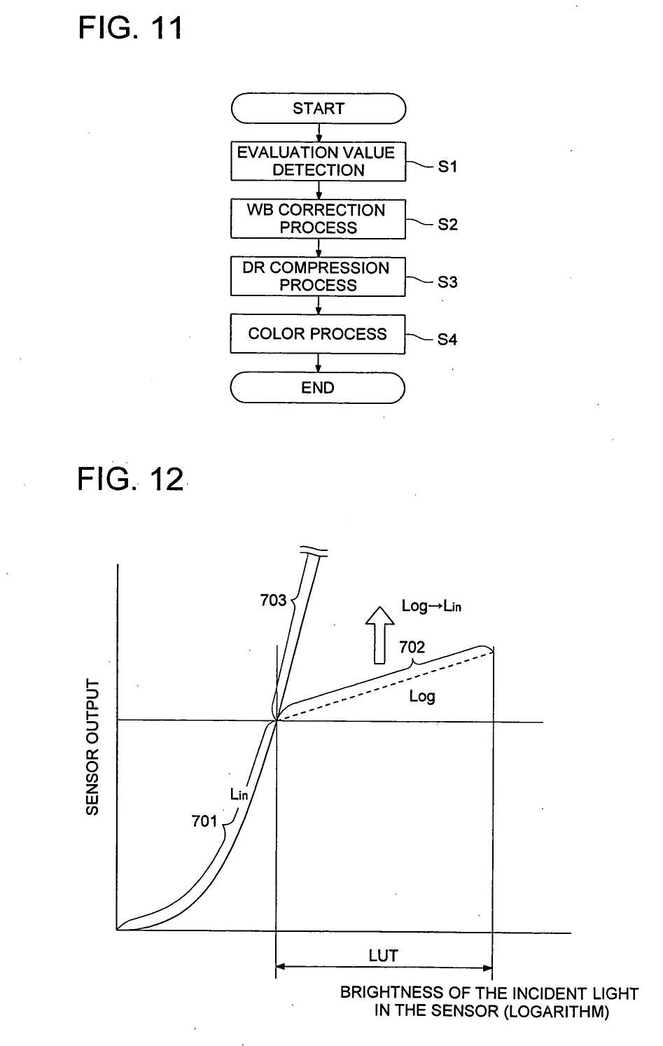

FIG. 11 is a flow chart showing an example of the image processing operation by the image processing section 6 of the digital camera 1. Firstly, by the evaluation value detection section 80, from an image signal obtained by imaging by the image sensor 3, a WB evaluation value as one of evaluation values which becomes a base value when executing imaging operation control is detected (Step S1). Next, by the preceding processing section 610, using the concerned detected WB evaluation value, the white balance correction process is performed by the white balance correction section 610, and the photoelectric conversion characteristics of the colors R, G, and B are unified to the same photoelectric conversion characteristic (the photoelectric conversion characteristic of the standard color G) (Step S2). And, the DR compression process (gradation conversion process) is performed by the DR compression section 62 and images having different photoelectric conversion characteristics composed of the logarithmic characteristic and linear characteristic are converted to images having the same photoelectric conversion characteristic (logarithmic characteristic) (Step S3). After the processes of the preceding processing section 610 at Steps S2 and S3 are performed, for the concerned images having the same photoelectric conversion characteristic, the image process by the succeeding processing section 620, that is, the succeeding color process by the color interpolation section 63, color correction section 64, gamma correction section 65, and color space conversion section 66 is performed (Step S4). Further, Steps S2 and S3 of the flow aforementioned may be interchanged in the order.

As mentioned above, according to the image pickup apparatus (the digital camera 1) of this embodiment, the image sensor 3 (solid-state image sensor) has two or more different photoelectric conversion characteristics (here, has two different photoelectric conversion characteristics of the linear characteristic and logarithmic characteristic) and an imaging signal from the image sensor 3 is processed by the image processing section 6). And, by the DR compression section 62 (gradation conversion processing section) installed in the image processing section 6, for the imaging signal from the image sensor 3, the gradation conversion process (DR compression process) of unifying different photoelectric conversion characteristics to the same photoelectric conversion characteristic (here, the linear characteristic) or bringing them close to the same photoelectric conversion characteristic is performed and by the succeeding processing section 620 installed in the image processing section 6 (the color processing section for performing the succeeding color process by the color interpolation section 63, color correction section 64, and color space conversion section 66), for the imaging signal, at least one color process among the color processes including at least the color interpolation process, color correction process, and color space conversion process is performed. The gradation conversion process and color process are executed in the order that the color process is performed after the gradation conversion process. As mentioned above, by use of such a constitution that the photoelectric conversion characteristics of image data are unified to the same or almost the same characteristic and then the color process is performed for the concerned image data, the color process can be performed by using the conventional color processing section (color processing method) without installing separately an exclusive color processing section for the image sensor 3 (linear/logarithmic images), and an occurrence of faults such as a color shift can be prevented or reduced, thus the quality of picked-up images (linear/logarithmic images) can be improved.

Further, the DR compression section 62, as a gradation conversion process of unifying different photoelectric conversion characteristics to the same or bringing them close to the same, performs a process of making the photoelectric conversion characteristic on the high brightness side and the photoelectric conversion characteristic on the low brightness side coincide with each other or bringing them close to each other, so that for example, image data having photoelectric conversion characteristics composed of the logarithmic characteristic and linear characteristic can be unified to and handled as image data of the linear characteristic, thus the concerned color process for linear/logarithmic images can be performed by using the conventional color processing section (color processing method) for linear images.

Further, the DR compression section 62, as a gradation conversion process of unifying different photoelectric conversion characteristics to the same or bringing them close to the same, performs the dynamic range compression process of compressing the illumination light component of the imaging signal, so that not only it can unify the concerned different photoelectric conversion characteristics to the same or bringing them close to the same but also for linear/logarithmic images, by keeping the contrast on the low brightness side, it can improve the contrast on the high brightness side.

Further, the white balance correction process is performed by the white balance correction section 61 before the gradation conversion process (DR compression process), so that in the white balance correction process before the gradation conversion process, for example, a process of making a different photoelectric conversion characteristic for each color of R, G, and B in a linear/logarithmic image coincide with any photoelectric conversion characteristic is performed, thus the gradation conversion process of a linear/logarithmic image and the subsequent image process can be handled easily.

Further, by the white balance correction section 61, the white balance correction process of making the photoelectric conversion characteristic of each color of R, G, and B coincide with the photoelectric conversion characteristic of the standard color of the concerned colors of R, G, and B, for example, the color G is performed, so that a different photoelectric conversion characteristic is not handled for each color of R, G, and B, that is, a linear image and a logarithmic image of image data of each color of R, G, and B can be handled together as a same image and high efficiency (simplification, high speed) in the gradation conversion process or the subsequent image process can be realized.

Further, by the image processing method of this embodiment, the imaging signal from the image sensor 3 (solid-state image sensor) having two or more different photoelectric conversion characteristics (here, has two different photoelectric conversion characteristics of the linear characteristic and logarithmic characteristic) is processed by the image processing section 6, and at the first step, for the imaging signal, the gradation conversion process (DR compression process) of unifying different photoelectric conversion characteristics to the same or bringing them close to the same is performed by the DR compression section 62 (the gradation conversion processing section), and at the second step, for the imaging signal, at least one of the color processes including at least the color interpolation process, color correction process, and color space conversion process is performed by the succeeding processing section 620 (the color processing section for performing the succeeding color process by the color interpolation section 63, color correction section 64, and color space conversion section 66), and the first step and second step are executed in the order that the second step is performed after the first step. As mentioned above, by use of such a constitution that the photoelectric conversion characteristics of image data are unified to the same characteristic or almost the same characteristic and then the color process is performed for the concerned image data, the color process can be performed by using the conventional color processing section (color processing method) without installing separately an exclusive color processing section for the image sensor 3 (linear/logarithmic images), and an occurrence of faults such as a color shift can be prevented or reduced, thus the quality of picked-up images (linear/logarithmic images) can be improved.

Further, the present invention can take the aspects indicated below. (A) The embodiment aforementioned uses a constitution that the DR compression section 62 divides image data into image data of a logarithmic characteristic area and a linear characteristic area, divides the image data of the linear characteristic area and logarithmic characteristic area into a reflectance component and a lighting component, performs the compression process for the lighting component, converts linearly the image data in the logarithmic characteristic area, thereby unifies and handles the whole image data as linear data. However, the process of extracting the lighting component of each characteristic area from the image data is performed like this, thus the process is complicated, and the circuit scale and processing time are required to increase, so that the DR compression section 62 may be structured so that the processing constitution in the case shown in FIGS. 12 and 13 performs a simple gradation conversion process.

Case 1

As shown in FIG. 12, the gradation conversion is performed to set only the high-brightness area (a logarithmic characteristic area 702) having a different photoelectric conversion characteristic from that of the low-brightness area (a linear characteristic area 701) to the same photoelectric conversion characteristic (linear characteristic) as that of the low-brightness area (set to a linear characteristic area 703). Further, the gradation conversion is performed using the LUT. In this case, the inclination of the photoelectric conversion characteristic of the high-brightness area is increased, so that there is a disadvantage of an increase in the image data amount (bus width) (for example, the conventional 16-bit width is increased to a 32-bit width), though in a state that the inclination of the photoelectric conversion characteristic of the low-brightness area (brightness resolution), that is, the contrast of the low-brightness area is kept, the subsequent process can be performed.

Case 2

As shown in FIG. 13, the gradation conversion is performed so as to reduce the inclination of the photoelectric conversion characteristic of the low-brightness area (a linear characteristic area 711) (to lower the inclination so as to become a linear characteristic area 712) and set the photoelectric conversion characteristic of the high-brightness area (a logarithmic characteristic area 713) to the same photoelectric conversion characteristic (a linear characteristic area 714) as that of the low-brightness area. Further, the gradation conversion is performed using the LUT. In this case, there are disadvantages that the inclination of the photoelectric conversion characteristic of the low-brightness area is reduced and the brightness resolution (contrast) in the low-brightness area is reduced, though the inclination of the photoelectric conversion characteristic in the low-brightness area can be reduced, so that compared with the case shown in FIG. 12, the image data amount (bus width) to be handled can be reduced.

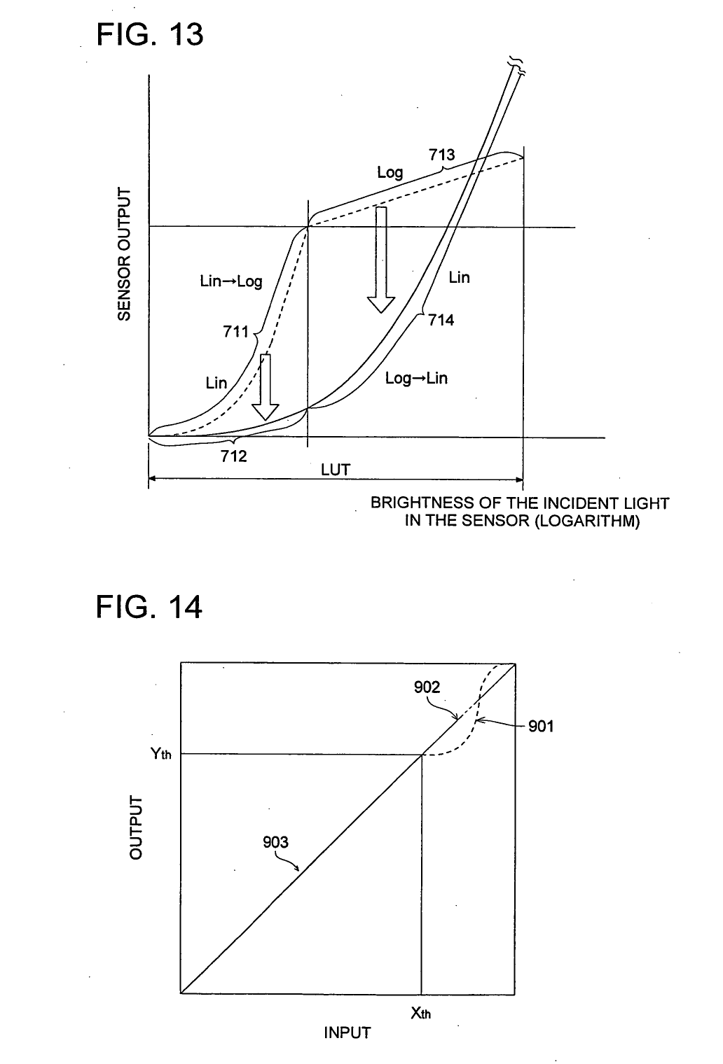

(B) As a method for unifying the photoelectric conversion characteristic on the high brightness side (the logarithmic characteristic area) to the photoelectric conversion characteristic on the low brightness side (the linear characteristic area) so as to unify the photoelectric conversion characteristics to the same characteristic, in addition to the modification aspect (A) aforementioned, for example, as shown in FIG. 14, only for the logarithmic characteristic area (the area having a pixel value of Yth or larger), a histogram equalization process (HE) may be performed. In this case, according to the “frequency” of the logarithmic characteristic area, a conversion table. (LUT) having conversion information which will be changed to a conversion characteristic 901 shown in the drawing is prepared, and the image data (pixels) in the original logarithmic characteristic area is converted using the conversion table, thus the concerned conversion characteristic 901 is obtained (however, the curved line shape of the conversion characteristic 901 is not limited to the one shown in the drawing). Therefore, assuming the pixel value of the original logarithmic characteristic area as a conversion characteristic 901, the characteristics can be approximated (brought close) to a linear gradation conversion characteristic (a linear characteristic 902), that is, the same linear characteristic as a linear characteristic area 903. Further, the aforementioned histogram equalization is one of the conventional general contrast emphatic methods, which is a method for converting the brightness value of each pixel so as to distribute uniformly the image brightness histogram (density histogram), thereby emphasizing the contrast. This is realized, for example, by preparing a mapping curve (tone curve) of accumulated brightness histograms of an original image (accumulated histogram) and converting the brightness (density, gray level) of all the pixels of the original image using the mapping curve.

(C) In the embodiment aforementioned, a constitution that the DR compression process for the pickup image by the image sensor 3 is performed by the process (of the DR compression section 62) in the digital camera 1 is used. However, the constitution is not limited to it and a constitution that the DR compression process is executed by a predetermined processing section outside the camera may be used. Concretely, for example, in a predetermined host computer (for example, a personal computer (PC) or a personal digital assistant (PDA, a portable information terminal for an individual)) having a user interface (UI) which is directly connected (wired) to the digital camera 1 using a USB or is network-connected by a radio LAN or is structured so as to transfer information using a storage medium such as a memory card, the DR compression process may be executed.

In this case, the host computer receives the information of the photoelectric conversion characteristic obtained by the digital camera 1 (for example, information on the inflection point) and a still image or a moving image obtained by compressing an image signal by the controller 8 before the DR compression process (gradation conversion process), that is, a JPEG (motion-JPEG included) image or an MPEG image, or a straight RAW format image and displays the image data (inflection point position information) on the monitor display unit of the host computer using predetermined application software (viewer software). And, by the application software, according to instruction input (operation) by a user, the DR compression processing method of the embodiment aforementioned is set, and on the basis of it, for example, a constitution that a LUT for the DR compression process (image conversion process) is prepared, thus the DR compression process is executed may be used.

Further, the information of the photoelectric conversion characteristic aforementioned may be generally described in an Exif header where internal information of a digital camera possessed by an image file of the camera is stored or may be separately described in an exclusive information file of photoelectric conversion characteristic information. Further, the white balance correction process, similarly to the DR compression process, may be structured so as to be performed by a predetermined host computer outside the digital camera 1 (the image processing section 6).

According to a preferred embodiment of the present invention, an image pickup apparatus and an image processing method can be provided. The image pickup apparatus is for performing the color process using the conventional color processing section (color processing method) without installing separately an exclusive color processing section for the LOG sensor (linear/logarithmic images), preventing or reducing an occurrence of faults such as a color shift, thereby improving the quality of picked-up images (linear/logarithmic images).

A preferred embodiment of the present invention is an image pickup apparatus including a solid-state image sensor having two or more different photoelectric conversion characteristics and an image processing section for processing an imaging signal from the solid-state image sensor, and the image processing section includes a gradation conversion processing section for performing a gradation conversion process of unifying the different photoelectric conversion characteristics aforementioned or bringing them close to the same for the imaging signal aforementioned and a color processing section for performing at least one of the color processes including at least the color interpolation process, color correction process, and color space conversion process for the imaging signal aforementioned, and performs the color process by the color processing section after the gradation conversion process by the gradation conversion processing section.

By use of above constitution, the solid-state image sensor has two or more different photoelectric conversion characteristics and the imaging signal from the solid-state image sensor is processed by the image processing section. And, by the gradation conversion processing section installed in the image processing section, for the imaging signal from the solid-state image sensor, the gradation conversion process of unifying different photoelectric conversion characteristics to the same photoelectric conversion characteristic or bringing them close to the same photoelectric conversion characteristic is performed and by the color processing section installed in the image processing section, at least one of the color processes including at least the color interpolation process, color correction process, and color space conversion process is performed for the concerned imaging signal. The gradation conversion process and color process are executed in the order that the color process is performed after the gradation conversion process. As mentioned above, by use of such a constitution that the photoelectric conversion characteristics of image data are unified to the same or almost the same characteristic and then the color process is performed for the concerned image data, the color process can be performed by using the conventional color processing section (color processing method) without installing separately an exclusive color processing section for the LOG sensor (linear/logarithmic images), and an occurrence of faults such as a color shift can be prevented or reduced, thus the quality of picked-up images (linear/logarithmic images) can be improved.

According to another aspect of the preferred embodiment of the present invention, the gradation conversion processing section, as a gradation conversion process of unifying the different photoelectric conversion characteristics aforementioned to the same or bringing them close to the same, performs a process of making the photoelectric conversion characteristic on the high brightness side and the photoelectric conversion characteristic on the low brightness side coincide with each other or bringing them close to each other. By use of this constitution, the gradation conversion processing section, as a gradation conversion process of unifying different photoelectric conversion characteristics to the same or bringing them close to the same, performs a process of making the photoelectric conversion characteristic on the high brightness side and the photoelectric conversion characteristic on the low brightness side coincide with each other or bringing them close to each other, so that for example, image data having photoelectric conversion characteristics composed of the logarithmic characteristic (high brightness side) and linear characteristic (low brightness side) can be unified to and handled as image data of the linear characteristic, thus the concerned color process for linear/logarithmic images can be performed by using the conventional color processing section (color processing method) for linear images.

According to another aspect of the preferred embodiment of the present invention, the gradation conversion processing section aforementioned, as the gradation conversion process aforementioned, performs a dynamic range compression process of compressing the illumination light component of the imaging signal aforementioned. By use of this constitution, the gradation conversion processing section, as a gradation conversion process of unifying different photoelectric conversion characteristics to the same or bringing them close to the same, performs the dynamic range compression process of compressing the illumination light component of the imaging signal, so that not only it can unify the concerned different photoelectric conversion characteristics to the same or bringing them close to the same but also for linear/logarithmic images, by keeping the contrast on the low brightness side, it can improve the contrast on the high brightness side.

According to another aspect of the preferred embodiment of the present invention, further includes a white balance correction section for performing a white balance correction process and the white balance correction section performs the concerned white balance correction process before the gradation conversion process aforementioned. By use of this constitution, the white balance correction process is performed by the white balance correction section before the gradation conversion process, so that in the white balance correction process before the gradation conversion process, for example, a process of making a different photoelectric conversion characteristic for each color of R, G, and B in a linear/logarithmic image coincide with any photoelectric conversion characteristic is performed, thus the gradation conversion process of a linear/logarithmic image and subsequent image process can be handled easily.

According to another aspect of the preferred embodiment of the present invention, the white balance correction section performs the white balance correction process of making the photoelectric conversion characteristic of each color of R, G, and B coincide with the photoelectric conversion characteristic of the standard color of each concerned color of R, G, and B. By use of this constitution, by the white balance correction section, the white balance correction process of making the photoelectric conversion characteristic of each color of R, G, and B coincide with the photoelectric conversion characteristic of the standard color of the concerned colors of R, G, and B, for example, the color G is performed, so that a different photoelectric conversion characteristic is not handled for each color of R, G, and B, that is, a linear image and a logarithmic image of image data of each color of R, G, and B can be handled together as a same image and high efficiency (simplification, high speed) in the gradation conversion process or the subsequent image process can be realized.

According to a preferred embodiment of the present invention of an image processing method, the method is an image processing method for processing an imaging signal from a solid-state image sensor having two or more different photoelectric conversion characteristics by the image processing section, has a first step of performing the gradation conversion process of unifying the different photoelectric conversion characteristics to the same or bringing them close to the same by the gradation conversion processing section for the imaging signal and a second step of performing at least one of the color processes including at least the color interpolation process, color correction process, and color space conversion process by the color processing section for the imaging signal, and performs the second step after the first step.

By use of this constitution, the imaging signal form the solid-state image sensor having two or more different photoelectric conversion characteristics is processed by the image processing section, and at the first step, for the imaging signal, the gradation conversion process of unifying different photoelectric conversion characteristics to the same or bringing them close to the same is performed by the gradation conversion processing section, and at the second step, for the imaging signal, at least one of the color processes including at least the color interpolation process, color correction process, and color space conversion process is performed by the color processing section, and the first step and second step are executed in the order that the second step is performed after the first step. As mentioned above, by use of such a constitution that the photoelectric conversion characteristics of image data are unified to the same or almost the same and then the color process is performed for the concerned image data, the color process can be performed by using the conventional color processing section (color processing method) without installing separately an exclusive color processing section for the LOG sensor (linear/logarithmic images), and an occurrence of faults such as a color shift can be prevented or reduced, thus the quality of picked-up images (linear/logarithmic images) can be improved.

What is claimed is:

1. An image pickup apparatus, comprising:
a solid-state image sensor which has two or more different photoelectric conversion characteristics; and
an image processing section which processes an image signal outputted from the solid-state image sensor;
wherein the image processing section comprises,
a gradation conversion processing section which executes a gradation conversion process on the image signal to conform or approximate the different photoelectric conversion characteristics to each other, and
a color processing section which executes on the image signal at least one color process out of those processes which include color interpolation process, color correction process and color space conversion process,
wherein the color processing section executes the color process after the gradation conversion processing section executes the gradation conversion process.

2. The image pickup apparatus of claim 1, wherein the gradation conversion processing section executes a process to conform or approximate the photoelectric conversion characteristics of the high intensity side to the photoelectric characteristics of the low intensity side as the gradation conversion process for conforming or approximating the different photoelectric conversion characteristics to each other.

3. The image pickup apparatus of claim 1, wherein the gradation conversion processing section executes a dynamic range compression process to compress the illumination light component of the image signal.

4. The image pickup apparatus of claim 1 comprises a white balance correction section which executes a white balance correction process,
wherein the white balance correction section executes the white balance correction process before the gradation conversion process.

5. The image pickup apparatus of claim 4, wherein the white balance correction section executes a white balance correction process to conform a photoelectric conversion characteristics of each color of RGB to a photoelectric conversion characteristics of one of the each color of RGB as a standard color.

6. The image pickup apparatus of claim 1, wherein the solid-state image sensor generates an electric signal in response to an amount of an incident light, and has a photoelectric conversion characteristics including a first region and a second region, wherein in the first region the electric signal changes at a predetermined rate in response to an amount of an incident light, and in the second region the image signal changes at a smaller rate than in the first region in response to the incident light,
wherein the second region exists in the blighter side of the first region.

7. The image pickup apparatus of claim 1 comprises a control signal generating section which generates a dynamic range control signal to adjust a position of an output level point where the photoelectric conversion characteristics of the solid-state image sensor switches from one to another.

8. An image processing method processing an image signal outputted from a solid-state image sensor which has two or more different photoelectric conversion characteristics, comprises steps of:
a first step executing a gradation conversion process on the image signal to conform or approximate the different photoelectric conversion characteristics to each other; and
a second step executing on the image signal at least one color process out of those processes which include a color interpolation process, a color correction process and a color space conversion process;
wherein the second step is executed after the first step.

9. The image processing method of claim 8, wherein the first step executes a process to conform or approximate a photoelectric conversion characteristics of a high intensity side to a photoelectric characteristics of a low intensity side as the gradation conversion process for conforming or approximating the different photoelectric conversion characteristics to each other.

10. The image processing method of claim 8, wherein the first step executes a dynamic range compression process to compress an incident light component of the image signal as the gradation conversion process to conform or to approximate the different photoelectric conversion characteristics to each other.

11. The image processing method of claim 8 comprises a third step which executes a white balance correction, wherein the third step is executed before the first step.

12. The image processing method of claim 11, wherein the third step executes the white balance correction process to conform a photoelectric conversion characteristics of each color of RGB to a photoelectric conversion characteristics of a standard color in the each color of RGB.

13. The image processing method of claim 8, wherein the solid-state image sensor generates an electric signal in response to an amount of an incident light, and has a photoelectric conversion characteristics including a first region and a second region, wherein in the first region the electric signal changes at a predetermine rate in response to an amount of an incident light, and in the second region the image signal changes at a smaller rate than in the first region in response to the incident light,
wherein the second region exists in the blighter side of the first region.

14. An image pickup apparatus, comprising:
a solid-state image sensor which generates an electric signal in response to an amount of an incident light and has a linier characteristic region where the electric signal is converted linearly in response to an amount of the incident light and an logarithmic characteristic region, provided on a brighter side of the linear characteristic region, where the electric signal is converted logarithmically in response to the amount of the incident light; and
an image processing section which processes an image signal outputted from the solid-state image sensor;
wherein the image processing section comprises,
a gradation conversion processing section which executes a gradation conversion process on the image signal to conform or approximate photoelectric conversion characteristics of the linear characteristic region and the logarithmic characteristic region to each other, and
a color processing section which executes on the image signal at least one of those color processes which include a color interpolation process, a color correction process and a color space conversion process,
wherein the color processing section executes the color process after the gradation conversion processing section executes the gradation conversion process.

15. The image pickup apparatus of claim 14, wherein the gradation conversion processing section executes a process to conform or approximate the photoelectric conversion characteristics of the high intensity side to the photoelectric characteristics of the low intensity side as the gradation conversion process for conforming or approximating photoelectric conversion characteristics of the linear characteristic region and the logarithmic characteristic region to each other.

16. The image pickup apparatus of claim 14, wherein the gradation conversion processing section executes a dynamic range compression process to compress an illumination component of the image signal as the gradation conversion process for conforming or approximating photoelectric conversion characteristics of the linear characteristic region and the logarithmic characteristic region to each other.

17. The image pickup apparatus of claim 14 comprises a white balance correction section which executes a white balance correction process,
wherein the white balance correction section executes the white balance correction process before the gradation conversion process.

18. The image pickup apparatus of claim 14, wherein the white balance correction section executes a white balance correction process to conform a photoelectric conversion characteristics of each color of RGB to a photoelectric conversion characteristics of one of the each color of RGB as a standard color.
